(19) United States
(12) Patent Application Publication
(10) Pub. No.: US 2011/0280020 A1
(43) Pub. Date: Nov. 17, 2011

(54) ILLUMINATION STRUCTURE AND LAMP TUBE STRUCTURE FOR GENERATING SPECIFIC DIRECTIONAL LIGHT SOURCES

(75) Inventors: WEI-CHUN CHEN, TAIPEI CITY (TW); PEI-HUNG MENG, TAIPEI COUNTY (TW); FANG-PO WANG, TAIPEI COUNTY (TW)

(73) Assignee: LEDTECH ELECTRONICS CORP., TAIPEI COUNTY (TW)

(21) Appl. No.: 12/917,664

(22) Filed: Nov. 2, 2010

(30) Foreign Application Priority Data
May 12, 2010 (TW) 99208864

(51) Int. Cl. F21V 29/00; F21V 5/00

(52) U.S. Cl. 362/294; 362/311.01; 362/311.02

(57) ABSTRACT

An illumination structure for generating specific directional light sources includes a substrate unit, a light-emitting unit and a lens unit. The substrate unit has at least one substrate body. The light-emitting unit has a plurality of light-emitting elements disposed on and electrically connected to the substrate body. The lens unit has a plurality of lens modules sequentially abutted against each other and disposed on the substrate body. Each lens module has a lens frame disposed on the substrate body and a plurality of protruding lens elements separated from each other by a predetermined distance and integrally formed on the lens frame, the protruding lens elements respectively correspond to the light-emitting elements, and each protruding lens element has at least one concave portion formed on a top side thereof and above each light-emitting element and at least two protrusion portions respectively integrally connected to two opposite sides of the concave portion.

### BACKGROUND OF THE INVENTION

1. Field of the Invention

The instant disclosure relates to an illumination structure and a lamp tube structure, and more particularly, to an illumination structure and a lamp tube structure for generating specific directional light sources.

2. Description of Related Art

The invention of the lamp greatly changed the style of building construction and the living style of human beings. Traditional lighting devices such as lamps that adopt incandescent bulbs, fluorescent bulbs, or power-saving bulbs have been generally well-developed and used intensively indoor illumination. However, compared to the newly developed light-emitting-diode (LED) lamps, these traditional lamps have the disadvantages of quick attenuation, high power consumption, high heat generation, short working life, high fragility, and being not recyclable. Thus, various high-powered LED lamps are created to replace the traditional lighting devices. Among them, tubular LED lamps are gaining popularity for their dimensional resemblance of traditional fluorescent tubes and thus their adoptability to existing lighting devices.

Particularly, the lighting units used for illuminating store merchandises, such as goods on shelf-display or products in the refrigerator, are desirable to possess high brightness and uniform light projecting capabilities. High brightness units such as halogen lights are conventionally adapted for such purposes. However, like all the conventional lighting devices mentioned above, the halogen like also suffer from high operating temperature and low energy efficiency. Thus, the advantage of adapting LED lighting devices for these purposes is apparent. However, conventional LED designs often fall short in providing the uniform light projection capability. For one thing, there are many frames and posts in the LED structure that undesirably limit the projecting direct of light beams generated by LED lamp tube; part of the light beams would be blocked by the frames or the posts, thus reducing the light utilization rate. In addition, the LED lamp of the prior art can only generate small light-projecting angle, thus the user needs to use more LED lamps to generate large light-projecting angle to illuminate all of the merchandise for reducing dark region.

### SUMMARY OF THE INVENTION

One particular aspect of the instant disclosure is to provide an illumination structure for generating specific directional light sources, thus the instant disclosure can generate more large light-projecting angle for illuminating more large region.

Another particular aspect of the instant disclosure is to provide a lamp tube structure for generating specific directional light sources, thus the instant disclosure can generate more large light-projecting angle for illuminating more large region.

To achieve the above-mentioned advantages, the instant disclosure provides an illumination structure for generating specific directional light sources, including: a substrate unit, a light-emitting unit and a lens unit. The substrate unit has at least one substrate body. The light-emitting unit has a plurality of light-emitting elements disposed on and electrically connected to the at least one substrate body. The lens unit has a plurality of lens modules sequentially abutted against each other and disposed on the at least one substrate body. Each lens module has a lens frame disposed on the at least one substrate body and a plurality of protruding lens elements separated from each other by a predetermined distance and integrally formed on the lens frame, the protruding lens elements respectively correspond to the light-emitting elements, and each protruding lens element has at least one concave portion formed on a top side thereof and above each light-emitting element and at least two protrusion portions respectively integrally connected to two opposite sides of the concave portion.

To achieve the above-mentioned advantages, the instant disclosure provides an illumination structure for generating specific directional light sources, including: a substrate unit, a light-emitting unit and a lens unit. The substrate unit has at least one substrate body. The light-emitting unit has a plurality of light-emitting elements disposed on and electrically connected to the at least one substrate body. The lens unit has a lens module disposed on the at least one substrate body. The lens module has a lens frame disposed on the at least one substrate body and a plurality of protruding lens elements separated from each other by a predetermined distance and integrally formed on the lens frame, the protruding lens elements respectively correspond to the light-emitting elements, and each protruding lens element has at least one concave portion formed on a top side thereof and above each light-emitting element and at least two protrusion portions respectively integrally connected to two opposite sides of the concave portion.

To achieve the above-mentioned advantages, the instant disclosure provides a lamp tube structure for generating specific directional light sources, including: a substrate unit, a light-emitting unit, a lens unit, a heat-dissipating unit, a lamp shell unit and a lateral cover unit. The substrate unit has at least one substrate body. The light-emitting unit has a plurality of light-emitting elements disposed on and electrically connected to the at least one substrate body. The lens unit has a plurality of lens modules sequentially abutted against each other and disposed on the at least one substrate body. Each lens module has a lens frame disposed on the at least one substrate body and a plurality of protruding lens elements separated from each other by a predetermined distance and integrally formed on the lens frame, the protruding lens elements respectively correspond to the light-emitting elements, and each protruding lens element has at least one concave portion formed on a top side thereof and above each light-emitting element and at least two protrusion portions respectively integrally connected to two opposite sides of the concave portion. The heat-dissipating unit has at least one heat-dissipating element disposed on a bottom side of the at least one substrate body. The lamp shell unit is disposed above the lens unit. The lateral cover unit has two cover elements. The substrate unit, the light-emitting unit, the lens unit, the heat-dissipating unit and the lamp shell unit are disposed between the two cover elements.

To achieve the above-mentioned advantages, the instant disclosure provides a lamp tube structure for generating specific directional light sources, including: a substrate unit, a light-emitting unit, a lens unit, a heat-dissipating unit, a lamp shell unit and a lateral cover unit. The substrate unit has at least one substrate body. The light-emitting unit has a plurality of light-emitting elements disposed on and electrically connected to the at least one substrate body. The lens unit has a lens module disposed on the at least one substrate body. The lens module has a lens frame disposed on the at least one substrate body and a plurality of protruding lens elements separated from each other by a predetermined distance and integrally formed on the lens frame, the protruding lens elements respectively correspond to the light-emitting elements, and each protruding lens element has at least one concave portion formed on a top side thereof and above each light-emitting element and at least two protrusion portions respectively integrally connected to two opposite sides of the concave portion. The heat-dissipating unit has at least one heat-dissipating element disposed on a bottom side of the at least one substrate body. The lamp shell unit is disposed above the lens unit. The lateral cover unit has two cover elements. The substrate unit, the light-emitting unit, the lens unit, the heat-dissipating unit and the lamp shell unit are disposed between the two cover elements.

Therefore, when the light beams generated by the light-emitting elements pass through the lens modules, most of the light beams can only pass through the two protrusion portions of each protruding lens element to naturally generate two directional light sources due to the design of the concave portion of the two protrusion portions of each protruding lens element. Hence, the lamp tube structure of the instant disclosure can generate a plurality of specific directional light sources by controlling the number of the protrusion portions and controlling the interval between every two protrusion portions that are formed on the two sides of each concave portion.

To further understand the techniques, means and effects the instant disclosure takes for achieving the prescribed objectives, the following detailed descriptions and appended drawings are hereby referred, such that, through which, the purposes, features and aspects of the instant disclosure can be thoroughly and concretely appreciated. However, the appended drawings are provided solely for reference and illustration, without any intention that they be used for limiting the instant disclosure.

### BRIEF DESCRIPTION OF THE DRAWINGS

FIG. 1A shows a perspective, exploded, schematic view of the lamp tube structure according to the first embodiment of the instant disclosure;

FIG. 1B shows a perspective, assembled, schematic view of the lamp tube structure according to the first embodiment of the instant disclosure;

FIG. 1C shows a lateral, cross-sectional, schematic view of the lamp tube structure according to the first embodiment of the instant disclosure;

FIG. 2 shows a lateral, cross-sectional, schematic view of the lamp tube structure according to the second embodiment of the instant disclosure;

FIG. 3 shows a lateral, cross-sectional, schematic view of the lamp tube structure according to the third embodiment of the instant disclosure;

FIG. 4 shows a lateral, cross-sectional, schematic view of the lamp tube structure according to the fourth embodiment of the instant disclosure;

FIG. 5 shows a lateral, cross-sectional, schematic view of the lamp tube structure according to the fifth embodiment of the instant disclosure; and

FIG. 6 shows a perspective, exploded, schematic view of the lamp tube structure according to the sixth embodiment of the instant disclosure.

### DETAILED DESCRIPTION OF THE PREFERRED EMBODIMENTS

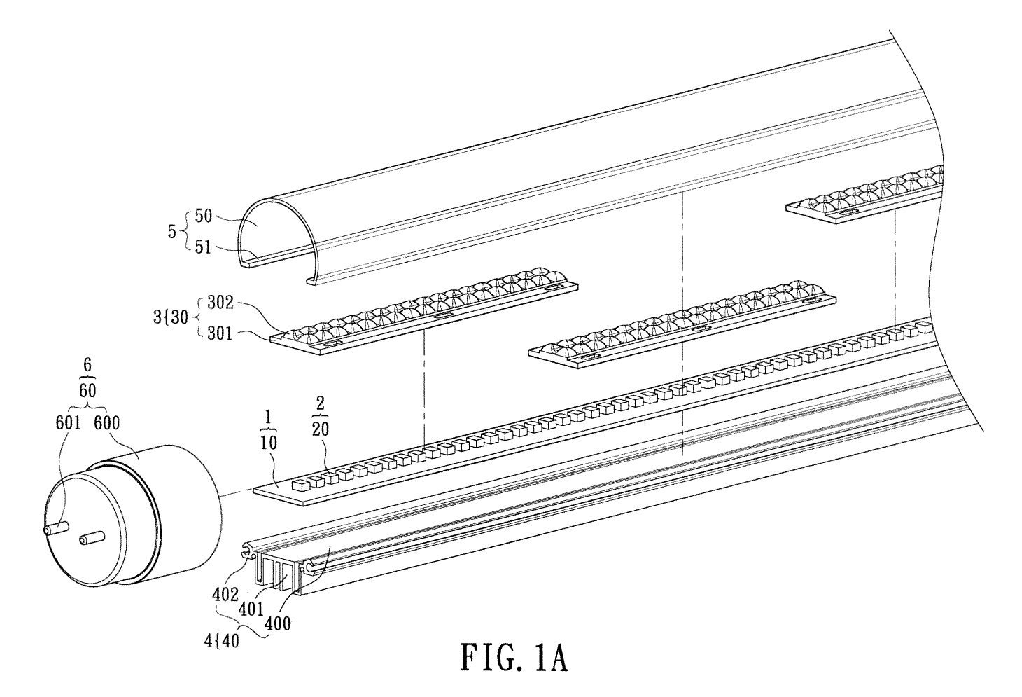

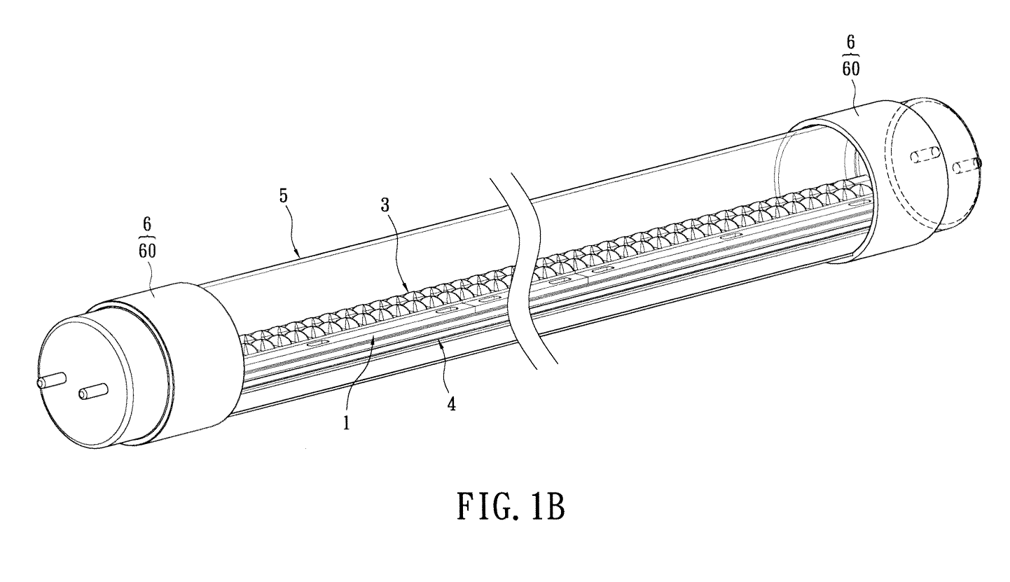

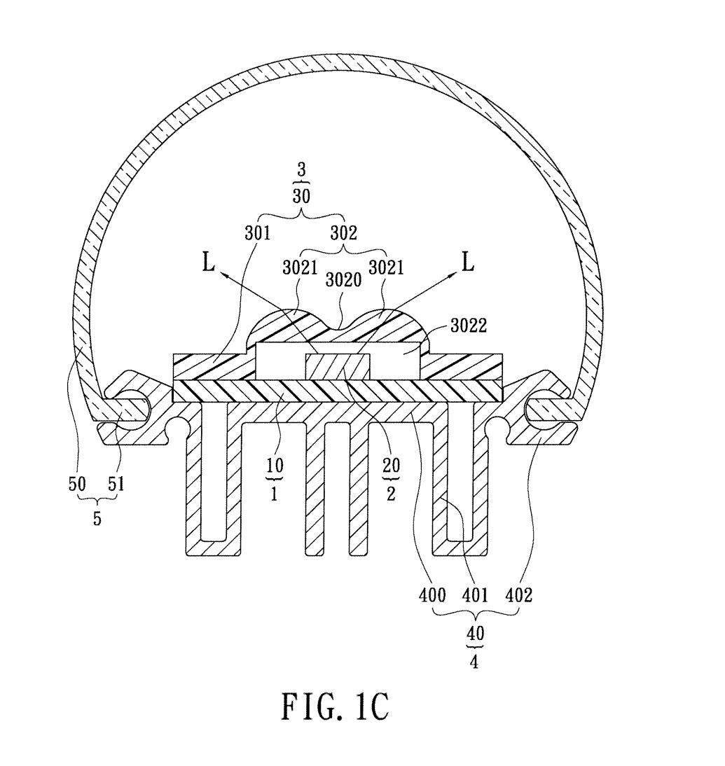

Referring to FIGS. 1A to 1C, the first embodiment of the instant disclosure provides a lamp tube structure for generating specific directional light sources, including: a substrate unit 1, a light-emitting unit 2, a lens unit 3, a heat-dissipating unit 4, a lamp shell unit 5 and a lateral cover unit 6.

The substrate unit 1 has at least one substrate body 10. For example, the substrate body 10 may be a circuit substrate having circuits formed thereon or an aluminum substrate having circuits formed thereon.

The light-emitting unit 2 has a plurality of light-emitting elements 20 disposed on and electrically connected to the substrate body 10. For example, each light-emitting element 20 may be an LED element that has been packaged by package resin (not shown) and can be electrically connected to the substrate body 10 by surface-mount technology, or each light-emitting element 20 may be an LED chip electrically contacting the substrate body 10 by COB (Chip On Board) technology. In the first embodiment, each light-emitting element 20 has been packaged by package resin (not shown) and can be electrically connected to the substrate body 10 by surface-mount technology.

The lens unit 3 has a plurality of lens modules 30 sequentially abutted against each other and disposed on the substrate body 10. For example, the lens modules 30 can be sequentially fixed on the substrate body 10 through many screw elements (not shown), and every two lens modules 30 are almost seamlessly abutted against each other. In addition, each lens module 30 has a lens frame 301 disposed on the substrate body 10 and a plurality of protruding lens elements 302 separated from each other by a predetermined distance and integrally formed on the lens frame 301. Each lens frame is used as a support frame for respectively supporting the protruding lens elements 302 above the light-emitting elements 20, thus the protruding lens elements 302 respectively correspond to the light-emitting elements 20. Moreover, each protruding lens element 302 has at least one concave portion 3020 formed on a top side thereof and above each light-emitting element 20 and at least two protrusion portions 3021 respectively integrally connected to two opposite sides of the concave portion 3020 (as shown in FIG. 1C). Furthermore, the lens unit 3 defines a receiving portion 3022 under the protruding lens elements 302 for receiving the light-emitting element 20 (the LED elements).

Therefore, light beams L generated by the light-emitting elements 20 can pass through the two protrusion portions 3021 of each protruding lens element 302 for generating two directional light sources. In other words, when the light beams L generated by the light-emitting elements 20 pass through the lens modules 30, most of the light beams L can only pass through the two protrusion portions 3021 of each protruding lens element 302 to naturally generate two directional light sources as shown in FIG. 1C due to the design of the concave portion 3020 of the two protrusion portions 3021 of each protruding lens element 302. Hence, the lamp tube structure of the instant disclosure can generate a plurality of specific directional light sources by controlling the number of the protrusion portions 3021 and controlling the interval between every two protrusion portions 3021 that are formed on the two sides of each concave portion 3020.

The heat-dissipating unit 4 has at least one heat-dissipating element 40 disposed on a bottom side of the substrate body 10. In addition, the heat-dissipating element 40 has a heat-dissipating body 400, a plurality of heat-dissipating fins 401 extended downward from a bottom side of the heat-dissipating body 400 and at least two first retaining portions 402 respectively disposed beside two lateral sides of the heat-dissipating body 400. In the first embodiment, the two first retaining portions 402 are extended upward and outward from the two outmost heat-dissipating fins 401, respectively.

The lamp shell unit 5 disposed above the lens unit 3, and the lamp shell unit 5 has a shell body 50 disposed above the lens unit 3 and at least two second retaining portions 51 respectively extended inward from two opposite ends of the shell body 50 and respectively mated with the two first retaining portions 402. In the first embodiment, referring to FIG. 1C, each first retaining portion 402 may has a retaining groove, and each second retaining portion 51 may has a retaining body received in and mated with the retaining groove. Of course, the retaining body of each second retaining portion 51 can be replaced by a retaining groove, and the retaining groove of each first retaining portion 402 can be replaced by a retaining body that can be received in and mated with the retaining groove.

Furthermore, the substrate unit 1, the light-emitting unit 2 and the lens unit 3 can be assembled together to form an illumination structure for generating specific directional light sources. Alternatively, the substrate unit 1, the light-emitting unit 2, the lens unit 3, the heat-dissipating unit 4 and the lamp shell unit 5 also can be assembled together to form an illumination structure for generating specific directional light sources.

The lateral cover unit 6 has two cover elements 60, and the substrate unit 1, the light-emitting unit 2, the lens unit 3, the heat-dissipating unit 4 and the lamp shell unit 5 are disposed between the two cover elements 60. Each cover element 60 has a cover body 600 disposed around one end portion of the heat-dissipating unit 4 and one end portion of the lamp shell unit 5 and at least two conductive pins 601 passing through the cover body 600, and the two conductive pins 601 of each cover element 60 can electrically connect to the substrate body 10 through conductive lines (not shown).

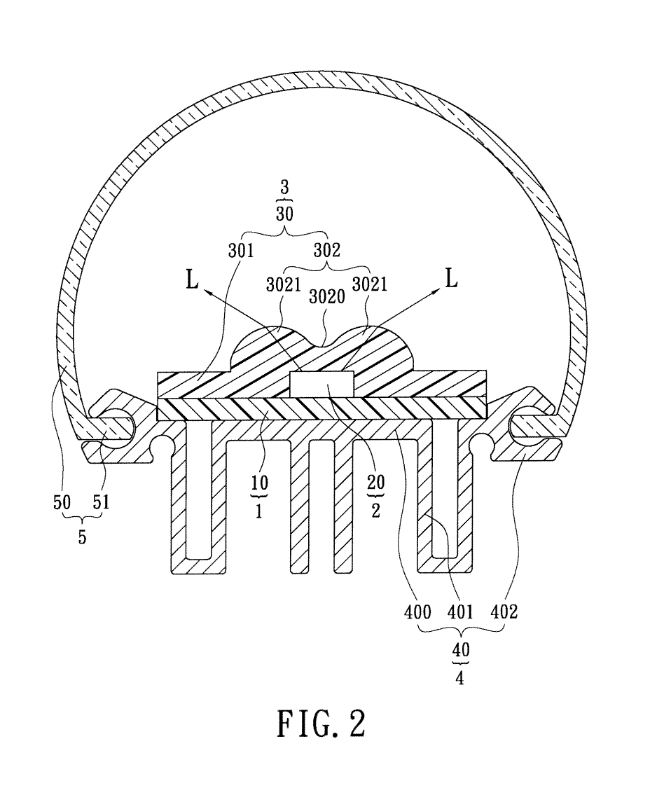

Referring to FIG. 2 the second embodiment of the instant disclosure provides a lamp tube structure for generating specific directional light sources, including: a substrate unit 1, a light-emitting unit 2, a lens unit 3, a heat-dissipating unit 4, a lamp shell unit 5 and a lateral cover unit (not shown). Comparing FIG. 2 with FIG. 1C, the difference between the second embodiment and the first embodiment is that: in the second embodiment, each light-emitting element 20 may be an LED chip electrically connected to the substrate body 10, and each light-emitting element 20 (each LED chip) defines an exposed outer surface covered with the lens unit 3. In other words, first, each light-emitting element 20 (each LED chip) can be electrically connected to the substrate body 10 by COB technology, next the exposed outer surface of each light-emitting element 20 is coved with package resin such as pure epoxy through a mold (not shown), and then the package resin is solidified to form the lens unit 3 with the lens modules 30, thus the exposed outer surface of each light-emitting element 20 is seamlessly coved with the lens modules 30.

Therefore, it is the same as the first embodiment, light beams L generated by the light-emitting elements 20 can pass through the two protrusion portions 3021 of each protruding lens element 302 for generating two directional light sources. In other words, when the light beams L generated by the light-emitting elements 20 pass through the lens modules 30, most of the light beams L can only pass through the two protrusion portions 3021 of each protruding lens element 302 to naturally generate two directional light sources as shown in FIG. 1C due to the design of the concave portion 3020 of the two protrusion portions 3021 of each protruding lens element 302. Hence, the lamp tube structure of the instant disclosure can generate a plurality of specific directional light sources by controlling the number of the protrusion portions 3021 and controlling the interval between every two protrusion portions 3021 that are formed on the two sides of each concave portion 3020.

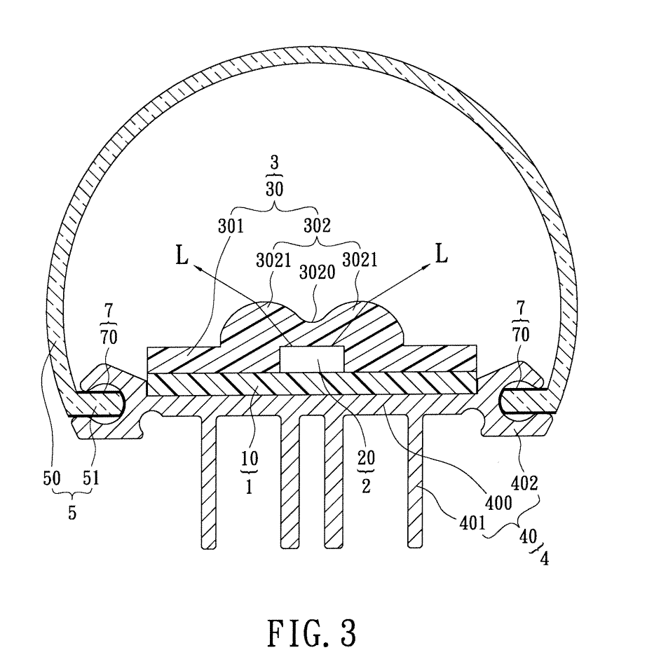

Referring to FIG. 3 the third embodiment of the instant disclosure provides a lamp tube structure for generating specific directional light sources, including: a substrate unit 1, a light-emitting unit 2, a lens unit 3, a heat-dissipating unit 4, a lamp shell unit 5, a lateral cover unit (not shown) and a sealing unit 7. Comparing FIG. 3 with FIG. 1C, the difference between the third embodiment and the first embodiment is that: the third embodiment further includes a sealing unit 7 that has at least two elastic sealing elements 70, and each elastic sealing element 70 is disposed between each first retaining portion 402 and each second retaining portion 51, thus each elastic sealing element 70 can be used as a waterproof strip for preventing external moisture from passing slot between each first retaining portion 402 and each second retaining portion 51 to enter the lamp shell unit 5. In addition, the heat-dissipating element 40 has a heat-dissipating body 400, a plurality of heat-dissipating fins 401 extended downward from a bottom side of the heat-dissipating body 400 and at least two first retaining portions 402 respectively extended outward from two lateral sides of the heat-dissipating body 400.

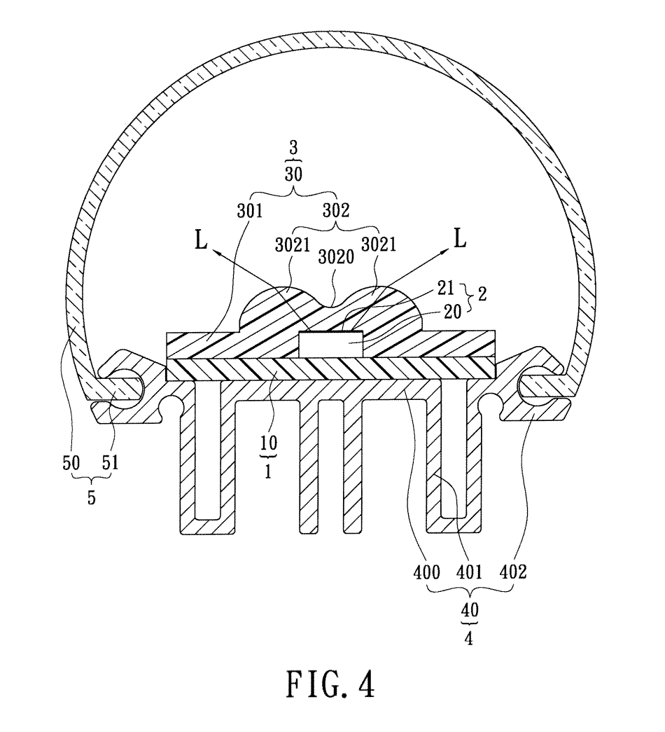

Referring to FIG. 4 the fourth embodiment of the instant disclosure provides a lamp tube structure for generating specific directional light sources, including: a substrate unit 1, a light-emitting unit 2, a lens unit 3, a heat-dissipating unit 4, a lamp shell unit 5 and a lateral cover unit (not shown). Comparing FIG. 4 with FIG. 2, the difference between the fourth embodiment and the second embodiment is that: in the fourth embodiment, the light-emitting unit 2 has a plurality of phosphor layers 21 respectively covering top surfaces of the light-emitting elements 20. For example, each light-emitting element 20 may be an LED chip, and after each light-emitting element 20 (each LED chip) is electrically connected to the substrate body 10 by COB technology, each phosphor layer 21 can be formed on each light-emitting element 20 by any forming method such as spraying, printing, coating etc. Therefore, when the light beams L (such as blue light beams) generated by each light-emitting element 20 (such as blue LED chip) pass through each phosphor layer 21, the blue light beams are transformed into white light beams.

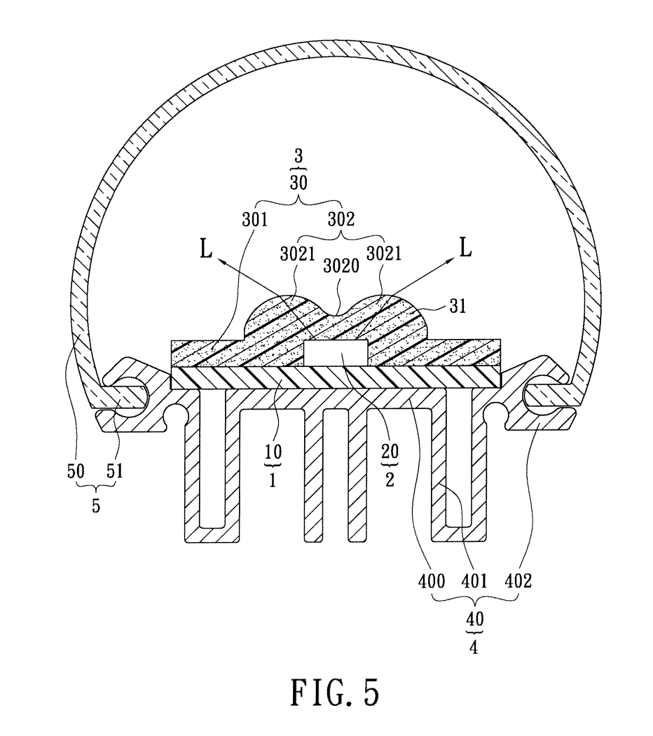

Referring to FIG. 5 the fifth embodiment of the instant disclosure provides a lamp tube structure for generating specific directional light sources, including: a substrate unit 1, a light-emitting unit 2, a lens unit 3, a heat-dissipating unit 4, a lamp shell unit 5 and a lateral cover unit (not shown). Comparing FIG. 5 with FIG. 2, the difference between the fifth embodiment and the second embodiment is that: in the fifth embodiment, the lens unit 3 has a plurality of phosphor powders 31 distributed inside each lens module 30, thus when the light beams L (such as blue light beams) generated by the light-emitting elements 20 (such as blue LED chips) pass through the lens unit 3, the blue light beams are transformed into white light beams. In other words, first, each light-emitting element 20 (each LED chip) can be electrically connected to the substrate body 10 by COB technology, next the exposed outer surface of each light-emitting element 20 is coved with package resin such as epoxy with phosphor powders 31 through a mold (not shown), and then the package resin is solidified to form the lens unit 3 with the lens modules 30.

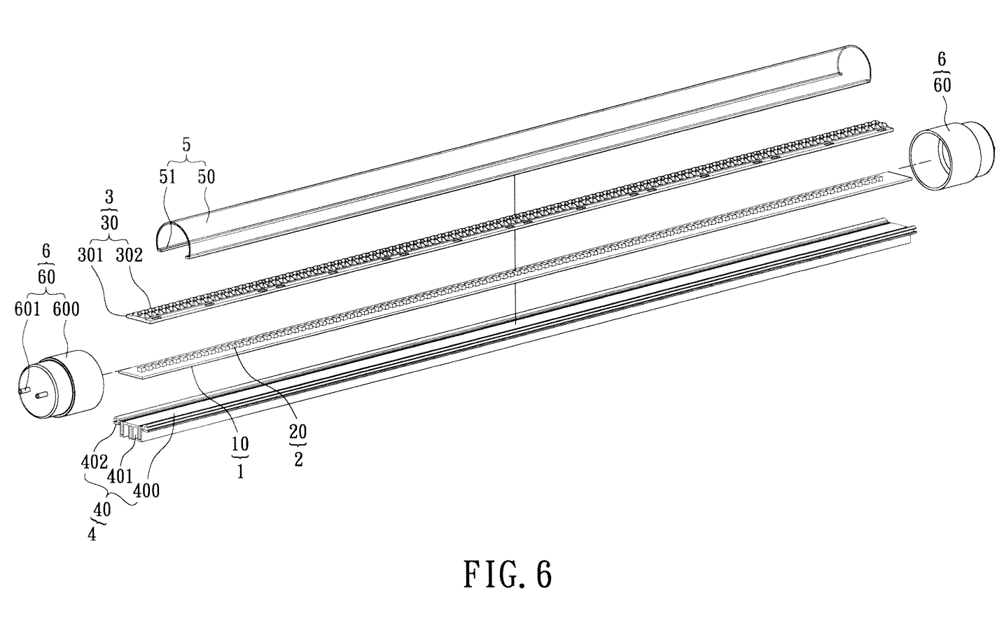

Referring to FIG. 6 the sixth embodiment of the instant disclosure provides a lamp tube structure for generating specific directional light sources, including: a substrate unit 1, a light-emitting unit 2, a lens unit 3, a heat-dissipating unit 4, a lamp shell unit 5 and a lateral cover unit 6. Comparing FIG. 6 with FIG. 1A, the difference between the sixth embodiment and the first embodiment is that: in the sixth embodiment, the lens unit 3 has a whole lens module 30 disposed on the substrate body 10, the whole lens module 30 has a lens frame 301 disposed on the substrate body 10 and a plurality of protruding lens elements 302 separated from each other by a predetermined distance and integrally formed on the lens frame 301, and the protruding lens elements 302 respectively correspond to the light-emitting elements 20. The same as the first embodiment (as shown in FIG. 1C), each protruding lens element 302 has at least one concave portion 3020 formed on a top side thereof and above each light-emitting element 20 and at least two protrusion portions 3021 respectively integrally connected to two opposite sides of the concave portion 3020.

In conclusion, when the light beams generated by the light-emitting elements pass through the lens modules, most of the light beams can only pass through the two protrusion portions of each protruding lens element to naturally generate two directional light sources due to the design of the concave portion of the two protrusion portions of each protruding lens element. Hence, the lamp tube structure of the instant disclosure can generate a plurality of specific directional light sources by controlling the number of the protrusion portions and controlling the interval between every two protrusion portions that are formed on the two sides of each concave portion.

The above-mentioned descriptions merely represent the preferred embodiments of the instant disclosure, without any intention or ability to limit the scope of the instant disclosure which is fully described only within the following claims. Various equivalent changes, alterations or modifications based on the claims of instant disclosure are all, consequently, viewed as being embraced by the scope of the instant disclosure.

What is claimed is:

1. An illumination structure for generating specific directional light sources, comprising:
a substrate unit having at least one substrate body;
a light-emitting unit having a plurality of light-emitting elements disposed on and electrically connected to the at least one substrate body; and
a lens unit having a plurality of lens modules sequentially abutted against each other and disposed on the at least one substrate body, wherein each lens module has a lens frame disposed on the at least one substrate body and a plurality of protruding lens elements separated from each other by a predetermined distance and integrally formed on the lens frame, the protruding lens elements respectively correspond to the light-emitting elements, and each protruding lens element has at least one concave portion formed on a top side thereof and above each light-emitting element and at least two protrusion portions respectively integrally connected to two opposite sides of the concave portion.

2. The illumination structure of claim 1, further comprising: a heat-dissipating unit having at least one heat-dissipating element disposed on a bottom side of the at least one substrate body, wherein the at least one heat-dissipating element has a heat-dissipating body, a plurality of heat-dissipating fins extended downward from a bottom side of the heat-dissipating body and at least two first retaining portions respectively disposed beside two lateral sides of the heat-dissipating body.

3. The illumination structure of claim 2, further comprising: a lamp shell unit that has a shell body disposed above the lens unit and at least two second retaining portions respectively extended inward from two opposite ends of the shell body and respectively mated with the at least two first retaining portions.

4. The illumination structure of claim 3, further comprising: a sealing unit that has at least two elastic sealing elements, wherein each elastic sealing element is disposed between each first retaining portion and each second retaining portion.

5. The illumination structure of claim 1, wherein the lens unit has a plurality of phosphor powders distributed inside each lens module.

6. The illumination structure of claim 1, wherein each light-emitting element is an LED element electrically connected to the at least one substrate body by surface-mount technology, and the lens unit defines a receiving portion under the protruding lens elements for receiving the LED elements.

7. The illumination structure of claim 1, wherein each light-emitting element is an LED chip electrically contacting the at least one substrate body, and each LED chip defines an exposed outer surface covered with the lens unit.

8. The illumination structure of claim 7, wherein the light-emitting unit has a plurality of phosphor layers respectively covering top surfaces of the LED chips.

9. An illumination structure for generating specific directional light sources, comprising:
a substrate unit having at least one substrate body;
a light-emitting unit having a plurality of light-emitting elements disposed on and electrically connected to the at least one substrate body; and
a lens unit having a lens module disposed on the at least one substrate body, wherein the lens module has a lens frame disposed on the at least one substrate body and a plurality of protruding lens elements separated from each other by a predetermined distance and integrally formed on the lens frame, the protruding lens elements respectively correspond to the light-emitting elements, and each protruding lens element has at least one concave portion formed on a top side thereof and above each light-emitting element and at least two protrusion portions respectively integrally connected to two opposite sides of the concave portion.

10. The illumination structure of claim 9, further comprising: a heat-dissipating unit having at least one heat-dissipating element disposed on a bottom side of the at least one substrate body, wherein the at least one heat-dissipating element has a heat-dissipating body, a plurality of heat-dissipating fins extended downward from a bottom side of the heat-dissipating body and at least two first retaining portions respectively disposed beside two lateral sides of the heat-dissipating body.

11. The illumination structure of claim 10, further comprising: a lamp shell unit that has a shell body disposed above the lens unit and at least two second retaining portions respectively extended inward from two opposite ends of the shell body and respectively mated with the at least two first retaining portions.

12. The illumination structure of claim 11, further comprising: a sealing unit that has at least two elastic sealing elements, wherein each elastic sealing element is disposed between each first retaining portion and each second retaining portion.

13. The illumination structure of claim 9, wherein the lens unit has a plurality of phosphor powders distributed inside the lens module.

14. The illumination structure of claim 9, wherein each light-emitting element is an LED element electrically connected to the at least one substrate body by surface-mount technology, and the lens unit defines a receiving portion under the protruding lens elements for receiving the LED elements.

15. The illumination structure of claim 9, wherein each light-emitting element is an LED chip electrically contacting the at least one substrate body, and each LED chip defines an exposed outer surface covered with the lens unit.

16. The illumination structure of claim 9, wherein the light-emitting unit has a plurality of phosphor layers respectively covering top surfaces of the LED chips.

17. A lamp tube structure for generating specific directional light sources, comprising:
a substrate unit having at least one substrate body;
a light-emitting unit having a plurality of light-emitting elements disposed on and electrically connected to the at least one substrate body;
a lens unit having a plurality of lens modules sequentially abutted against each other and disposed on the at least one substrate body, wherein each lens module has a lens frame disposed on the at least one substrate body and a plurality of protruding lens elements separated from each other by a predetermined distance and integrally formed on the lens frame, the protruding lens elements respectively correspond to the light-emitting elements, and each protruding lens element has at least one concave portion formed on a top side thereof and above each light-emitting element and at least two protrusion portions respectively integrally connected to two opposite sides of the concave portion;
a heat-dissipating unit having at least one heat-dissipating element disposed on a bottom side of the at least one substrate body;
a lamp shell unit disposed above the lens unit; and
a lateral cover unit having two cover elements, wherein the substrate unit, the light-emitting unit, the lens unit, the heat-dissipating unit and the lamp shell unit are disposed between the two cover elements.

18. The lamp tube structure of claim 17, wherein the at least one heat-dissipating element has a heat-dissipating body, a plurality of heat-dissipating fins extended downward from a bottom side of the heat-dissipating body and at least two first retaining portions respectively disposed beside two lateral sides of the heat-dissipating body; the lamp shell unit that has a shell body disposed above the lens unit and at least two second retaining portions respectively extended inward from two opposite ends of the shell body and respectively mated with the at least two first retaining portions; each cover element has a cover body disposed around one end portion of the heat-dissipating unit and one end portion of the lamp shell unit and at least two conductive pins passing through the cover body.

19. A lamp tube structure for generating specific directional light sources, comprising:
a substrate unit having at least one substrate body;
a light-emitting unit having a plurality of light-emitting elements disposed on and electrically connected to the at least one substrate body;
a lens unit having a lens module disposed on the at least one substrate body, wherein the lens module has a lens frame disposed on the at least one substrate body and a plurality of protruding lens elements separated from each other by a predetermined distance and integrally formed on the lens frame, the protruding lens elements respectively correspond to the light-emitting elements, and each protruding lens element has at least one concave portion formed on a top side thereof and above each light-emitting element and at least two protrusion portions respectively integrally connected to two opposite sides of the concave portion;
a heat-dissipating unit having at least one heat-dissipating element disposed on a bottom side of the at least one substrate body;
a lamp shell unit disposed above the lens unit; and
a lateral cover unit having two cover elements, wherein the substrate unit, the light-emitting unit, the lens unit, the heat-dissipating unit and the lamp shell unit are disposed between the two cover elements.

20. The lamp tube structure of claim 19, wherein the at least one heat-dissipating element has a heat-dissipating body, a plurality of heat-dissipating fins extended downward from a bottom side of the heat-dissipating body and at least two first retaining portions respectively disposed beside two lateral sides of the heat-dissipating body; the lamp shell unit that has a shell body disposed above the lens unit and at least two second retaining portions respectively extended inward from two opposite ends of the shell body and respectively mated with the at least two first retaining portions; each cover element has a cover body disposed around one end portion of the heat-dissipating unit and one end portion of the lamp shell unit and at least two conductive pins passing through the cover body.
